(19) United States
(12) Patent Application Publication
(10) Pub. No.: US 2016/0097465 A1
(43) Pub. Date: Apr. 7, 2016

(54) Closures Including Adjustment Tools for Adjustment Mechanisms

(71) Applicant: EMERSON ELECTRIC CO., St. Louis, MO (US)

(72) Inventors: George J. Sciuto, St. Louis, MO (US); Christian J. Mutschler, Ellisville, MO (US); Christopher J. Schroeder, St. Charles, MO (US); Vincent P. Fargo, St. Charles, MO (US)

(21) Appl. No.: 14/576,275

(22) Filed: Dec. 19, 2014

Related U.S. Application Data
(60) Provisional application No. 62/058,317, filed on Oct. 1, 2014.

(51) Int. Cl. F16K 31/50; F16K 1/48; F16K 27/02; F16K 1/36

(52) U.S. Cl. CPC F16K 31/504; F16K 1/36; F16K 1/48; F16K 27/02

(57) ABSTRACT

According to various aspects, exemplary embodiments are provided of closures including adjustment tools for adjustment mechanisms. In an exemplary embodiment, a closure for an adjustment mechanism includes a cap. The cap includes an adjustment tool configured to engage the adjustment mechanism for changing a position of the adjustment mechanism. In another example embodiment, a method of making a closure for an adjustment mechanism generally includes providing a cap with an adjustment tool. In another example embodiment, there is a method of adjusting an adjustment mechanism using a closure for the adjustment mechanism. In this example, the method generally includes removing the closure from the adjustment mechanism, changing a position of the adjustment mechanism using the adjustment tool of the closure, and re-installing the closure about the adjustment mechanism.

### CROSS-REFERENCE TO RELATED APPLICATION

This application claims the benefit of U.S. Provisional Application No. 62/058,317 filed Oct. 1, 2014. The entire disclosure of the above application is incorporated herein by reference.

### FIELD

The present disclosure generally relates to closures including adjustment tools for adjustment mechanisms.

### BACKGROUND

This section provides background information related to the present disclosure which is not necessarily prior art.

Valves or other components that are adjustable via an adjustment mechanism will typically have a closure in the form of a seal or protective cap over the adjustment mechanism to inhibit dirt from contaminating the mechanism and also to inhibit inadvertent damage.

### SUMMARY

This section provides a general summary of the disclosure, and is not a comprehensive disclosure of its full scope or all of its features.

According to various aspects, exemplary embodiments are provided of closures including adjustment tools for adjustment mechanisms. In an exemplary embodiment, a closure for an adjustment mechanism generally includes a cap configured to substantially cover at least a portion of an adjustment mechanism. The cap includes an adjustment tool configured to engage the adjustment mechanism for changing a position of the adjustment mechanism.

In another example embodiment, a method of making a closure for an adjustment mechanism generally includes providing a cap with an adjustment tool. The cap is configured to substantially cover at least a portion of the adjustment mechanism. The adjustment tool is configured to engage the adjustment mechanism for changing a position of the adjustment mechanism when the cap is removed from the adjustment mechanism.

According to yet another example embodiment, there is a method of adjusting an adjustment mechanism using a closure for the adjustment mechanism. In this example, the method generally includes removing the closure from the adjustment mechanism, changing a position of the adjustment mechanism using the adjustment tool of the closure, and re-installing the closure about the adjustment mechanism.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a sectional view of an exemplary embodiment of a valve having an adjustment mechanism and a closure where the closure includes an adjustment tool for rotating the adjustment mechanism according to aspects of the present disclosure;

FIG. 2 is a sectional view of an example closure and adjustment mechanism where the closure includes an adjustment tool for rotating the adjustment mechanism according to an example embodiment;

FIG. 3 is a perspective view of the closure and adjustment mechanism shown in FIG. 2; and

FIG. 4 is a sectional view of another example closure and adjustment mechanism where the closure includes an adjustment tool for rotating the adjustment mechanism according to another example embodiment;

FIG. 5 is perspective view of the closure and adjustment mechanism shown in FIG. 4;

FIG. 6 is a sectional view of another example closure and an adjustment mechanism where the closure includes an adjustment tool for rotating the adjustment mechanism according to yet another example embodiment; and

FIG. 7 is a perspective view of the closure and adjustment mechanism shown in FIG. 6.

Corresponding reference numerals indicate corresponding parts throughout the several views of the drawings.

### DETAILED DESCRIPTION

Example embodiments will now be described more fully with reference to the accompanying drawings.

Protective closures (e.g., caps, seals, covers, etc.) for adjustment mechanisms of valves, etc. may have to be removed in order to make adjustments to the adjustment mechanism (e.g., change a position of the adjustment mechanism, rotate the adjustment mechanism, etc.). Removing the closure may require tools, including a wrench, pliers, etc. After the protective closure is removed, a same and/or different adjustment tool (e.g., a wrench, pliers, special purpose tool, etc.) may be applied to the adjustment mechanism to make an adjustment. After the adjustment has been made, the tool may be removed and the closure may be re-installed or replaced.

During the adjustment process, the protective closure may be misplaced, lost, or the technician may forget to replace the protective closure, etc. In which case, the adjustment mechanism may then be left exposed. This may lead to physical damage of the adjustment mechanism and/or the inclusion of dirt, debris, etc. After recognizing the above problems, the inventors hereof recognized it would be more likely that the protective closure will be replaced after the adjustment if the closure included the adjustment tool because the adjustment tool and closure would thus be an integral part of the adjustment process. In which case, for example, an operator would not lose the closure because it will also be used for making the adjustment, e.g., for rotating the adjustment mechanism, etc.

In some example embodiments, the closure may be metal, rigid polymer, etc. The closure may incorporate a method of adjusting the valve or component in the form of a male protrusion, female pocket, etc. For example, the closure may include an adjustment tool as part of (e.g., built-in part, integral with, etc.) the closure. For example, an exterior end portion of the closure may include an engagement feature (e.g., a male protrusion, a female pocket, a recess, a slot, a portion shaped as a screwdriver, hex key, Allen wrench, etc.) that is configured to engage the corresponding engagement feature of the adjustment mechanism. In exemplary embodiments, the closure may include one of a male protrusion or female pocket, and the adjustment mechanism may include the other one of the male protrusion and female pocket.

If the closure is a seal cap for an adjustment mechanism having a male protrusion for rotating the adjustment mechanism, the seal cap may have a female pocket or recess in the end of the seal cap to engage the male protrusion of the adjustment mechanism in order to rotate the adjustment mechanism. Similarly, if the closure is a seal cap for an adjustment mechanism having a female pocket or recess for rotating the adjustment mechanism, the seal cap may have a male protrusion in the end of the seal cap to engage the female pocket of the adjustment mechanism in order to rotate the adjustment mechanism.

In some example embodiments, the closure may include an index (e.g., a rib, indicator, dot, marking, etc.) to indicate a position of the adjustment mechanism (e.g., to allow a count of the number of turns of the adjustment mechanism, an amount of rotation of the adjustment mechanism, etc.). For example, a rib on the closure may allow an operator to determine how far the adjustment mechanism has been rotated from its initial position, how many times the adjustment mechanism has fully rotated, etc.

In some example embodiments, the closure may be provided with threads to remove and/or replace the closure on the valve or other component having the adjustment mechanism. For example, an operator may remove and replace a seal cap by unscrewing the cap from the valve and then screwing the cap back on the valve. The closure may also include one or more sealing members, such as an O-ring, etc., to create a seal to protect the adjustment mechanism.

Some of the example embodiments described herein may provide one or more of (but not necessarily any or all of) the following advantages: reduces the need for additional tools to adjust the adjustment mechanism, reduces the risk of the protective closure being misplaced and not re-installed, decreases the risk of contamination or damage to the adjustment mechanism, reduces the possibility of applying excessive force when removing or replacing the protective closure, and/or reduces possible damage to the valve/component having the adjustment mechanism, etc.

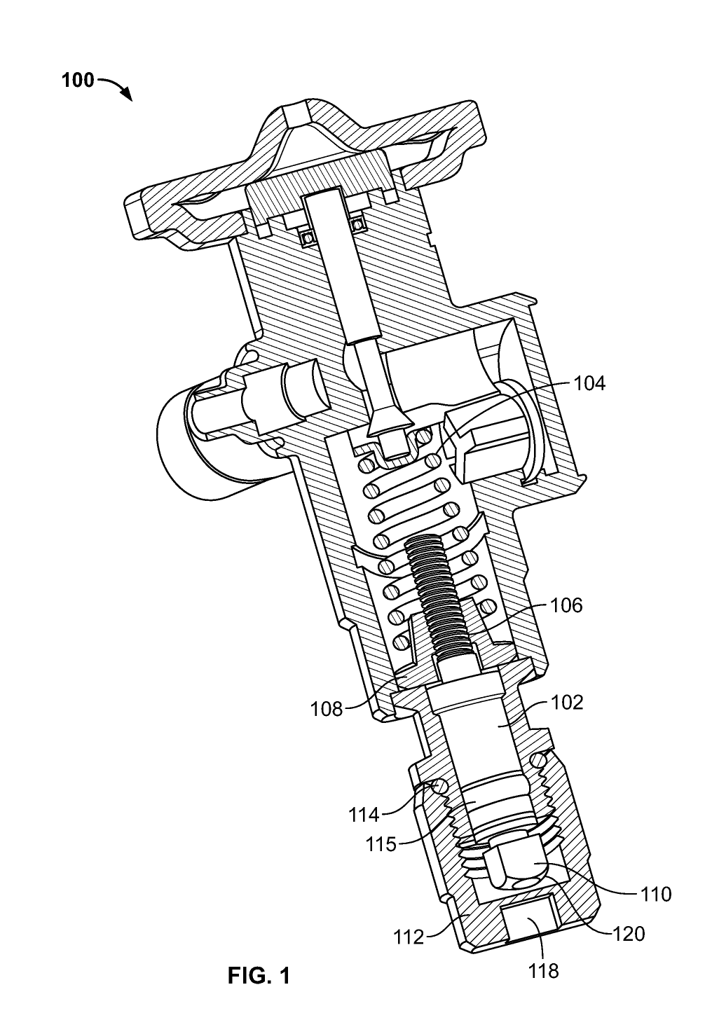

Referring now to the figures, FIG. 1 illustrates an exemplary embodiment of a valve 100 having an adjustment mechanism 102 and closure 112 according to aspects of the present disclosure. The adjustment mechanism 102 changes operation of the valve 100 when the adjustment mechanism 102 is rotated. For example, the adjustment mechanism 102 may compress the spring 104 when rotated based on the interaction of screw threads 106 of the adjustment mechanism 102 with displacement member 108. For example, rotation of the adjustment mechanism 102 in one direction may cause the displacement member 108 to move toward the spring 104 (upwardly in FIG. 1) to compress the spring 104. Rotation of the adjustment mechanism 102 in the opposite direction may cause the displacement member 108 to move away from the spring 104 (downwardly in FIG. 1), such that the spring 104 is less compressed by the displacement member 108.

The closure 112 defines an enclosure or interior 120 having an opening into which an end portion of the adjustment member 102 may be positioned. As shown in FIG. 1, the closure 112 substantially covers the adjustment mechanism 102 (including the male protrusion 110). For example, the closure 112 may include screw threads which allow the closure 112 to be placed about the end of the adjustment mechanism 102 by screwing the closure 112 onto threads of the adjustment mechanism 102 and/or valve 100. In other embodiments, other connection methods may be used (e.g., snap on closure, etc.).

The closure 112 may inhibit contamination (e.g., dirt, debris, water, etc.) from entering the adjustment mechanism 102 to protect operation of the adjustment mechanism 102. The closure 112 may inhibit damage to the adjustment mechanism 102, including damage from debris, damage from accidental contact with the adjustment mechanism 102, etc. The closure 112 (and/or other closures disclosed herein) may thus also be referred to herein as a protective closure.

With continued reference to FIG. 1, the closure 112 includes an adjustment tool 118 configured to engage a male protrusion 110 (e.g., similar to the head of a bolt, etc.) of the adjustment mechanism 102. The adjustment tool 118 may be used to engage the male protrusion 110 to rotate the adjustment mechanism 102 after the closure 112 is removed. Accordingly, the user can use the closure 112 to rotate the adjustment mechanism 102 instead of having to use a separate tool, such as wrench, pliers, etc.

In this example, the adjustment tool 118 includes a female pocket (e.g., square or four-sided recess, etc.) that is configured to engage the male protrusion 110 for rotating the adjustment mechanism 102. A user may first unscrew the closure 112 to remove it from the adjustment mechanism 102. Then, the user may position the male protrusion 110 within the female pocket or recess 118 of the closure 112. The user may then rotate the closure 112 to rotate and change the position of the adjustment 102.

The adjustment tool 118 is on or along an end portion of the closure 112. For example, the closure 112 may be a cap having the adjustment tool 118 along or on an end portion opposite the opening of the interior 120.

In this example embodiment, the closure 112 integrally defines the adjustment tool 118 such that the closure 112 and adjustment tool 118 have a single-piece or unitary construction (e.g., single molded piece, etc.). In other exemplary embodiments, the adjustment tool may be a separate component attached (e.g., adhesively bonded, fastened, etc.) to the closure.

The shape of the adjustment tool 118 depends on the shape of the corresponding feature of the adjustment mechanism 102. For example, because the adjustment mechanism 102 has a four-sided or square male protrusion 110 in this embodiment, the adjustment tool 118 of the closure 112 includes a four-sided or square female pocket or recess to engage the protrusion 110. In other embodiments that include an adjustment mechanism with a female pocket or recess, the closure includes an adjustment tool includes a corresponding male protrusion.

The closure 112 may be made of any suitable material or combination of materials, including metal, rigid polymer, etc. For example, the closure 112 may be a hard plastic cap.

A sealing mechanism 114 may be provided to substantially seal the adjustment mechanism 102 from outside elements (e.g., water, dirt, etc.) when the closure 112 is substantially covering the adjustment mechanism 102. The sealing mechanism 114 prevents inclusion of dirt and debris. The sealing mechanism 114 may include any suitable sealing mechanism, including one or more O-rings, etc. Another sealing mechanism or primary shaft seal 115 may also be provided to substantially seal the adjustment mechanism 102 to inhibit outside elements (e.g., water, dirt, etc.) from entering the valve 100 when the closure 112 is not installed or has been removed. The sealing mechanism 115 may include any suitable sealing mechanism, including one or more O-rings, etc. The sealing mechanism 114 may also operate or act as a second seal for the primary shaft seal 115.

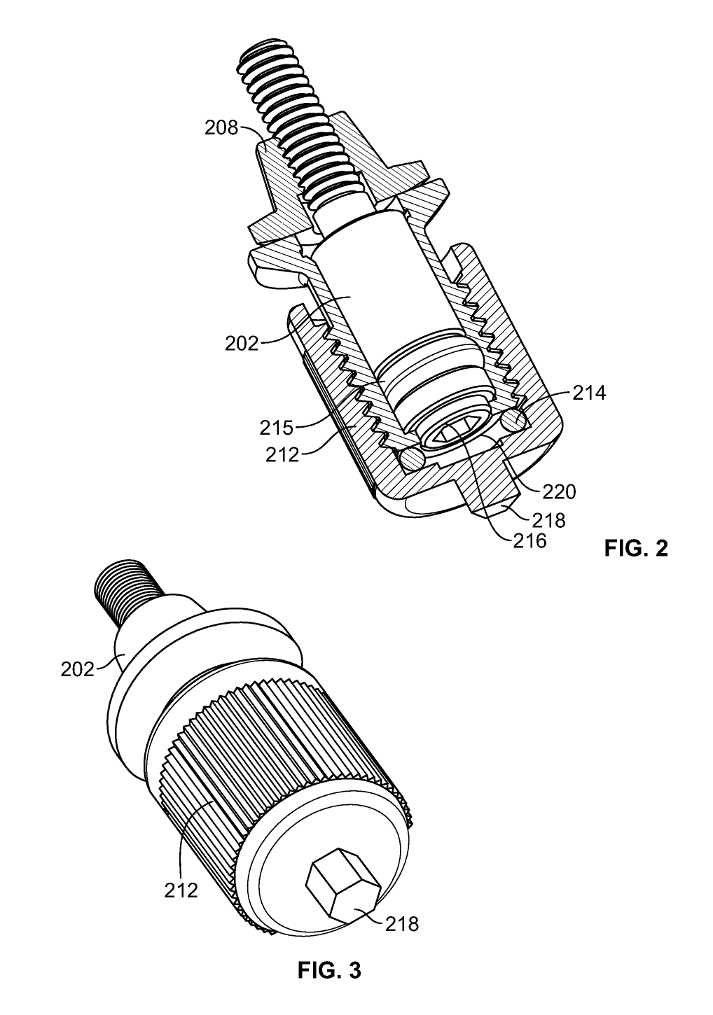

FIGS. 2 and 3 illustrate an adjustment mechanism 202 and closure 212 according to another example embodiment. The adjustment mechanism 202 includes a female pocket 216 which may be engaged using a separate tool (e.g., hex key, Allen wrench, etc.) for changing a position of the adjustment mechanism 202. The closure 212 also includes an adjustment tool 218 that may be used to engage the female pocket 216, such that rotation of the closure 212 rotates the adjustment mechanism 202.

In this exemplary embodiment, the adjustment tool 218 includes a male protrusion (e.g., portion shaped as a hex key, Allen wrench, square, etc.) that is insertable into the correspondingly shaped pocket 216 to rotate the adjustment mechanism 202. Rotation of the adjustment mechanism 202 in one direction may cause the displacement member 208 to move (e.g., upwardly in FIG. 2, etc.) toward a spring to compress the spring, whereas rotation in the opposite direction may cause the displacement member 208 to move (e.g., downwardly in FIG. 2, etc.) away from the spring.

The closure 212 defines an enclosure or interior 220 having an opening into which an end portion of the adjustment member 202 may be positioned. As shown in FIG. 2, the closure 212 substantially covers the adjustment mechanism 202 (including the male protrusion 210). For example, the closure 212 may include screw threads which allow the closure 212 to be placed about the end of the adjustment mechanism 202 by screwing the closure 212 onto threads of the adjustment mechanism 202 and/or valve. In other embodiments, other connection methods may be used (e.g., snap on closure, etc.).

The closure 212 may inhibit contamination (e.g., dirt, debris, water, etc.) from entering the adjustment mechanism 202 to protect operation of the adjustment mechanism 202. The closure 212 may inhibit damage to the adjustment mechanism 202, including damage from debris, damage from accidental contact with the adjustment mechanism 202, etc. The closure 212 (and/or other closures disclosed herein) may thus also be referred to herein as a protective closure.

The adjustment tool 218 is on or along an end portion of the closure 212. For example, the closure 212 may be a cap having the adjustment tool 218 along or on an end portion opposite the opening of the interior 220.

In this example embodiment, the closure 212 integrally defines the adjustment tool 218 such that the closure 212 and adjustment tool 218 have a single-piece or unitary construction (e.g., single molded piece, etc.). In other exemplary embodiments, the adjustment tool may be a separate component attached (e.g., adhesively bonded, fastened, etc.) to the closure.

The closure 212 may be made of any suitable material or combination of materials, including metal, rigid polymer, etc. For example, the closure 212 may be a hard plastic cap.

A sealing mechanism 214 (e.g., O-ring, etc.) may be used to substantially seal the adjustment mechanism 202 to protect it from outside elements (e.g., water, dirt, etc.) when the closure 212 is disposed about the adjustment mechanism 202. The sealing mechanism 214 prevents inclusion of dirt and debris. Another sealing mechanism or primary shaft seal 215 (e.g., O-ring, etc.) may also be provided to substantially seal the adjustment mechanism 202 to inhibit outside elements (e.g., water, dirt, etc.) from entering a valve when the closure 212 is not installed or has been removed. The sealing mechanism 214 may also operate or act as a second seal for the primary shaft seal 215.

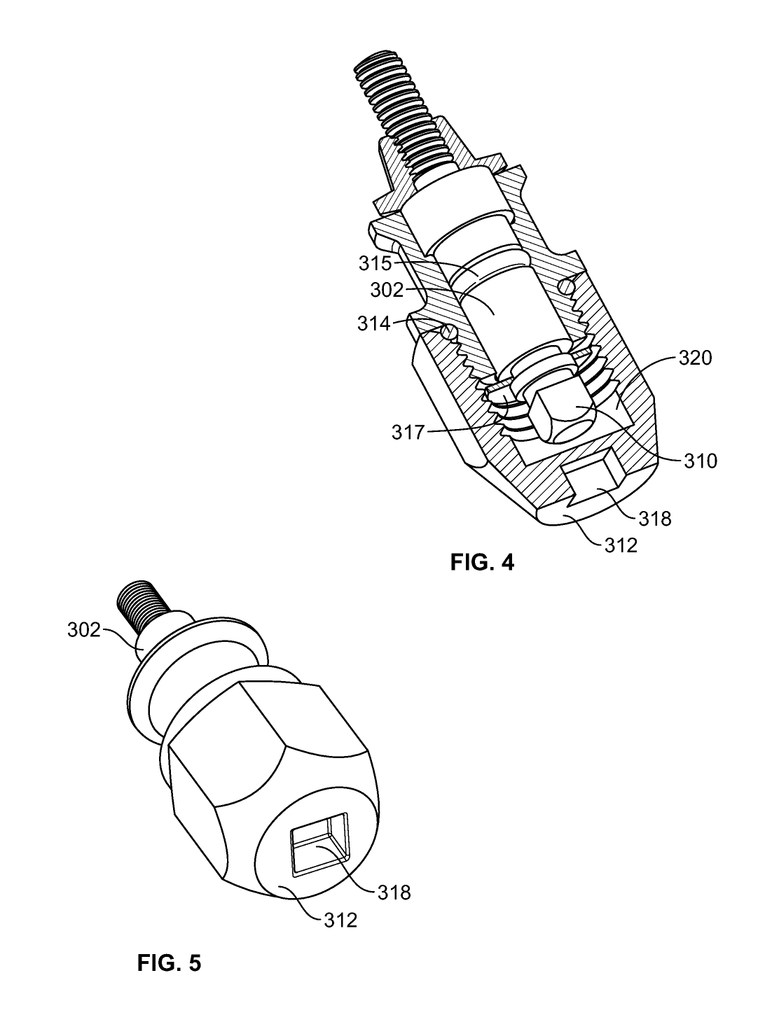

FIGS. 4 and 5 illustrate an adjustment mechanism 302 and a closure 312 according to another example embodiment. As shown in FIG. 4, the adjustment mechanism 302 includes a male protrusion 310 for rotating the adjustment mechanism 302.

In this example, the male protrusion 310 may comprise or be similar to a bolt head (e.g., a square, pentagonal or hexagonal bolt head, etc.). The male protrusion 310 may be engaged using a separate tool (e.g., socket wrench, monkey wrench, pliers, etc.) for changing a position of the adjustment mechanism 302. The closure 312 also includes an adjustment tool 318 that may be used to engage the male protrusion 310, such that rotation of the closure 312 rotates the adjustment mechanism 302.

The adjustment tool 318 includes a female pocket or recess (e.g., square or four-sided recess, etc.) that is configured to engage the male protrusion 310. A user may first unscrew the closure 312 to remove it from the adjustment mechanism 302. Then, the user may position the male protrusion 310 within the female pocket or recess 318 of the closure 312. The user may then rotate the closure 312 to rotate and change the position of the adjustment 302.

The adjustment tool 318 is on or along an end portion of the closure 312. For example, the closure 312 may be a cap having the adjustment tool 318 along or on an end portion opposite the opening of the interior 320.

In this example embodiment, the closure 312 integrally defines the adjustment tool 318 such that the closure 312 and adjustment tool 318 have a single-piece or unitary construction (e.g., single molded piece, etc.). In other exemplary embodiments, the adjustment tool may be a separate component attached (e.g., adhesively bonded, fastened, etc.) to the closure.

The closure 312 may be made of any suitable material or combination of materials, including metal, rigid polymer, etc. For example, the closure 312 may be a hard plastic cap.

A sealing mechanism 314 (e.g., O-ring, etc.) may be used to substantially seal the adjustment mechanism 302 to protect it from outside elements (e.g., water, dirt, etc.) when the closure 312 is disposed about the adjustment mechanism 302. The sealing mechanism 314 prevents inclusion of dirt and debris. Another sealing mechanism or primary shaft seal 315 (e.g., O-ring, etc.) may also be provided to substantially seal the adjustment mechanism 302 to inhibit outside elements (e.g., water, dirt, etc.) from entering a valve when the closure 312 is not installed or has been removed. The sealing mechanism 314 may also operate or act as a second seal for the primary shaft seal 315.

The adjustment mechanism 302 further includes a ring 317. The ring 317 is used to retain the shaft of the adjustment mechanism 302 and prevent it from being pushed into the housing during adjustment and causing incorrect adjustment. The ring 317 may also be used during initial assembly to allow pre-assembly of the components.

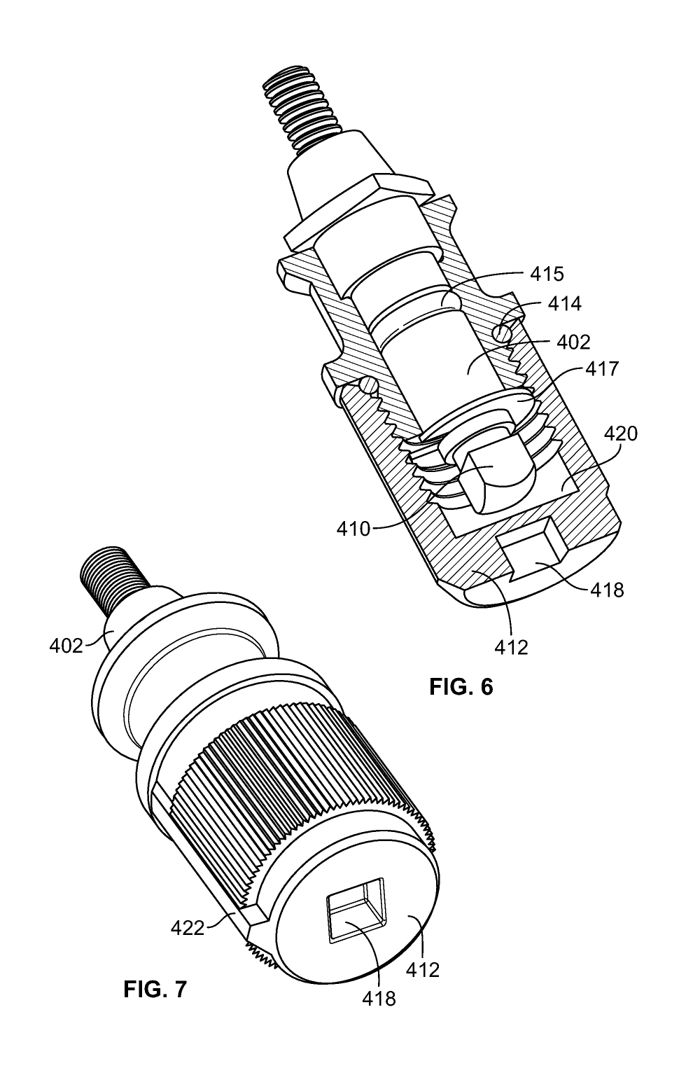

FIGS. 6 and 7 illustrate an adjustment mechanism 402 and a closure 412 according to another exemplary embodiment. As shown in FIG. 6, the adjustment mechanism 402 includes a male protrusion 410 for rotating the adjustment mechanism 402.

In this example, the male protrusion 410 may comprise or be similar to a bolt head (e.g., a square, pentagonal or hexagonal bolt head, etc.). The male protrusion 410 may be engaged using a separate tool (e.g., socket wrench, monkey wrench, pliers, etc.) for changing a position of the adjustment mechanism 402. The closure 412 also includes an adjustment tool 18 that may be used to engage the male protrusion 410, such that rotation of the closure 412 rotates the adjustment mechanism 402.

The adjustment tool 418 includes a female pocket or recess (e.g., square or four-sided recess, etc.) that is configured to engage the male protrusion 410. A user may first unscrew the closure 412 to remove it from the adjustment mechanism 402. Then, the user may position the male protrusion 410 within the female pocket or recess 418 of the closure 412. The user may then rotate the closure 312 to rotate and change the position of the adjustment 402.

The adjustment tool 418 is on or along an end portion of the closure 412. For example, the closure 412 may be a cap having the adjustment tool 418 along or on an end portion opposite the opening of the interior 420.

In this example embodiment, the closure 412 integrally defines the adjustment tool 418 such that the closure 412 and adjustment tool 418 have a single-piece or unitary construction (e.g., single molded piece, etc.). In other exemplary embodiments, the adjustment tool may be a separate component attached (e.g., adhesively bonded, fastened, etc.) to the closure.

As shown in FIG. 7, the closure 412 also includes an index 422. Although the index 422 is shown as a rib disposed along a side of the closure 412, other embodiments may include other suitable indexes, including an indicator, one or more markings on the surface of the closure, etc.

The index 422 may allow an operator to determine a position of the adjustment mechanism 402 as the adjustment mechanism 402 is being rotated. For example, the index 422 may allow the operator to visually, tactilely, etc. determine a number of turns of the adjustment mechanism 402, a change in position relative to the initial starting position of the adjustment mechanism 402, etc.

A sealing mechanism 414 (e.g., O-ring, etc.) may be used to substantially seal the adjustment mechanism 402 to protect it from outside elements (e.g., water, dirt, etc.) when the closure 412 is disposed about the adjustment mechanism 402. The sealing mechanism 414 prevents inclusion of dirt and debris. Another sealing mechanism or primary shaft seal 415 (e.g., O-ring, etc.) may also be provided to substantially seal the adjustment mechanism 402 to inhibit outside elements (e.g., water, dirt, etc.) from entering a valve when the closure 412 is not installed or has been removed. The sealing mechanism 414 may also operate or act as a second seal for the primary shaft seal 415.

The adjustment mechanism 402 further includes a ring 417. The ring 417 is used to retain the shaft of the adjustment mechanism 402 and prevent it from being pushed into the housing during adjustment and causing incorrect adjustment. The ring 417 may also be used during initial assembly to allow pre-assembly of the components.

According to another example embodiment, an exemplary method of making a protective closure for an adjustment mechanism generally includes providing a cap having an enclosure configured to substantially cover an adjustment mechanism to protect the adjustment mechanism from contamination and/or damage, and forming an adjustment tool on the cap, the adjustment tool configured to engage the adjustment mechanism to change a position of the adjustment mechanism.

The adjustment tool may include a male protrusion when the adjustment mechanism includes a female pocket for changing a position of the adjustment mechanism. The adjustment tool may include a female pocket when the adjustment mechanism includes a male protrusion for changing a position of the adjustment mechanism.

The method may include forming an index on the cap to indicate a position of the adjustment mechanism. The index may include a rib disposed along at least one side of the cap.

According to another example embodiment, a method of adjusting an adjustment mechanism using a protective closure for the adjustment mechanism generally includes removing the protective closure from the adjustment mechanism, changing a position of the adjustment mechanism using an adjustment tool defined by the protective closure, and re-installing the protective closure about the adjustment mechanism to protect the adjustment mechanism from contamination and/or damage.

The adjustment tool may include a male protrusion. In this example, changing a position of the adjustment mechanism includes engaging a female pocket or recess of the adjustment mechanism with the male protrusion and rotating the adjustment mechanism. The adjustment tool may include a female pocket or recess. In this example, changing a position of the adjustment mechanism includes engaging a male protrusion of the adjustment mechanism with the female pocket and rotating the adjustment mechanism.

The protective closure may include an index for indicating a position of the adjustment mechanism. The method may include determining a position of the adjustment mechanism using the index as the adjustment mechanism is rotated by the adjustment tool of the protective closure.

Exemplary embodiments of the closures disclosed herein may bused in a wide range of valves. Examples of valves include a thermal expansion valves, manually adjustable solenoid valves, manually opened and closed ball valves, etc. Accordingly, the example closures disclosed herein should not be limited to any one particular type of valve.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure for an adjustment mechanism, the closure comprising a cap configured to substantially cover at least a portion of an adjustment mechanism, the cap including an adjustment tool configured to engage the adjustment mechanism for changing a position of the adjustment mechanism.

2. The closure of claim 1, wherein the cap integrally defines the adjustment tool such that the cap and the adjustment tool have a single-piece unitary construction.

3. The closure of claim 1, wherein the adjustment tool comprises a male protrusion configured to engage a female pocket of the adjustment mechanism.

4. The closure of claim 1, wherein the adjustment tool comprises a female pocket configured to engage a male protrusion of the adjustment mechanism.

5. The closure of claim 1, wherein the adjustment tool comprises a recess having a shape corresponding to a shape of a bolt head of the adjustment mechanism, whereby engagement of the bolt head of the adjustment mechanism within the recess of the adjustment tool allows the cap to be used for rotating the adjustment mechanism

6. The closure of claim 1, wherein:
the cap defines an interior having an opening for receiving the at least a portion of the adjustment mechanism within the interior for protecting the at least a portion of the adjustment mechanism from contamination and/or damage; and
the cap includes an end portion opposite the opening and that includes the adjustment tool.

7. The closure of claim 1, wherein:
the closure is configured to inhibit dirt and debris from contaminating the adjustment mechanism; and/or
the closure further comprises one or more sealing mechanisms.

8. The closure of claim 1, wherein:
the cap includes interior screw threads configured to engage exterior screw threads disposed about at least a portion of the adjustment mechanism; and/or
the cap comprises at least one of a metal and a rigid polymer.

9. The closure of claim 1, wherein the cap includes an index for determining a position of the adjustment mechanism.

10. The closure of claim 9, wherein the index comprises a rib disposed along at least one side of the cap.

11. A valve comprising the closure of claim 1 and an adjustment mechanism including at least a portion substantially covered by the cap, wherein the adjustment mechanism includes one of a protrusion or a recess, and the adjustment tool of the cap includes the other one of said protrusion and recess, whereby the adjustment tool is engageable with the adjustment mechanism for rotating the adjustment mechanism.

12. A method of making a closure for an adjustment mechanism, the method including providing a cap with an adjustment tool, wherein the cap is configured to substantially cover at least a portion of the adjustment mechanism, and wherein the adjustment tool is configured to engage the adjustment mechanism for changing a position of the adjustment mechanism when the cap is removed from the adjustment mechanism.

13. The method of claim 12, wherein providing a cap with an adjustment tool comprises integrally forming the adjustment tool on the cap such that the cap and the adjustment tool have a single-piece unitary construction.

14. The method of claim 12, wherein the adjustment tool comprises a male protrusion when the adjustment mechanism includes a female pocket for changing a position of the adjustment mechanism.

15. The method of claim 12, wherein the adjustment tool comprises a female pocket when the adjustment mechanism includes a male protrusion for changing a position of the adjustment mechanism.

16. The method of claim 12, further comprising forming an index on the cap, the index configured to indicate a position of the adjustment mechanism.

17. The method of claim 16, wherein the index comprises a rib disposed along at least one side of the cap.

18. A method of adjusting an adjustment mechanism using a closure for the adjustment mechanism, the method comprising:
removing the closure from the adjustment mechanism, the closure including an adjustment tool;
changing a position of the adjustment mechanism using the adjustment tool of the closure; and
re-installing the closure about the adjustment mechanism.

19. The method of claim 18, wherein:
the adjustment tool includes a male protrusion, and changing a position of the adjustment mechanism includes engaging a female pocket of the adjustment mechanism with the male protrusion and rotating the adjustment mechanism; or
the adjustment tool includes a female pocket, and changing a position of the adjustment mechanism includes engaging a male protrusion of the adjustment mechanism with the female pocket and rotating the adjustment mechanism.

20. The method of claim 19, wherein:
the closure includes an index for indicating a position of the adjustment mechanism; and
the method further comprises determining a position of the adjustment mechanism using the index as the adjustment mechanism is rotated by the adjustment tool of the closure.
